(19) United States
(12) Patent Application Publication
(10) Pub. No.: US 2003/0101260 A1
(43) Pub. Date: May 29, 2003

(54) Method, computer program element and system for processing alarms triggered by a monitoring system

(75) Inventors: Marc Dacier, Mouans Sartoux (FR); Klaus Julisch, Kilchberg (CH)

Correspondence Address: Peter M. Klett, Intellectual Property Law Dept., IBM Corporation, P.O. Box 218, Yorktown Heights, NY, 10598, US

(73) Assignee: International Business Machines Corporation, Armonk, NY

(21) Appl. No.: 10/286,708

(22) Filed: Oct. 31, 2002

(30) Foreign Application Priority Data
Nov. 29, 2001 (EP) 01811156.7

(51) Int. Cl. G06F 15/173

(52) U.S. Cl. 709/224

(57) ABSTRACT

A method and system is proposed that allow to process alarms, that have been triggered by a monitoring system, by means of a model representing the normal alarm behavior of the monitoring system. The number of alarms, that have been triggered, and the number of alarms, that have been filtered by means of the model, are counted. Then the ratio between the number of alarms, that have been filtered, and the number of alarms, that have been triggered, is calculated; and the update of the model is started whenever the ratio has reached a first or a second threshold value. Thus in order to efficiently achieve an optimal over-all performance, an update of the model is always performed, whenever a decline in the model's performance is detected. In a preferred embodiment, alarms that have been triggered, are grouped depending on source address information contained therein. Groups of alarms, that display diverse behavior, are flagged and forwarded for closer investigation in order to identify suspicious source systems.

The present invention generally relates to a method, a computer program element and a system for processing alarms, that have been triggered by a monitoring system such as an intrusion detection system, a firewall or a network management system.

The present invention specifically relates to a method, a computer program element and a system for processing alarms by means of a model representing the normal alarm behavior of the monitoring system.

More particularly, the present invention relates to a method, a computer program element and a system for processing alarms, possibly containing a high percentage of false alarms, which are received at a rate that can not be handled efficiently by human system administrators.

### BACKGROUND OF THE INVENTION

According to Kathleen A. Jackson, INTRUSION DETECTION SYSTEM (IDS) PRODUCT SURVEY, Version 2.1, Los Alamos National Laboratory 1999, Publication No. LA-UR-99-3883, Chapter 1.2, IDS OVERVIEW, intrusion detection systems attempt to detect computer misuse. Misuse is the performance of an action that is not desired by the system owner; one that does not conform to the system's acceptable use and/or security policy. Typically, misuse takes advantage of vulnerabilities attributed to system misconfiguration, poorly engineered software, user neglect or abuse of privileges and to basic design flaws in protocols and operating systems.

Intrusion detection systems analyze activities of internal and/or external users for explicitly forbidden or anomalous behavior. They are based on the assumption that misuse can be detected by monitoring and analyzing network traffic, system audit records, system configuration files or other data sources (see also Dorothy E. Denning, IEEE TRANSACTIONS ON SOFTWARE ENGINEERING, VOL. SE-13, NO. 2, February 1987, pages 222-232).

The methods an intrusion detection system uses to detect misuse can vary. Essentially, there are two main intrusion detection methods, which are described for example in EP 0 985 995 A1 and document U.S. Pat. No. 5,278,901.

The first method uses knowledge accumulated about attacks and looks for evidence of their exploitation. This method, which on a basic level can be compared to virus checking methods, is referred to as knowledge-based, also known as signature-based or pattern-oriented or misuse detection. A knowledge-based intrusion detection system therefore looks for patterns of attacks while monitoring a given data source. As a consequence, attacks for which signatures or patterns are not stored, will not be detected.

According to the second method a reference model is built, that represents the normal behavior or profile of the system being monitored and looks for anomalous behavior, i.e. for deviations from the previously established reference model. Reference models can be built in various ways. For example in S. Forrest, S. A. Hofmeyr, A. Somayaji and T. A. Longstaff; A Sense of Self for Unix Processes, Proceedings of the 1996 IEEE Symposium on Research in Security and Privacy, IEEE Computer Society Press 1996, pages 120-128, normal process behavior is modeled by means of short sequences of system calls.

The second method is referred to as behavior-based, also known as profile-based or anomaly-based. Behavior-based intrusion detection, which relies on the assumption that the “behavior” of a system will change in the event that an attack is carried out, therefore allows to detect previously unknown attacks, as long as they deviate from the previously established normal behavior model. Under the condition that the normal behavior of the monitored system does not change, a behavior-based intrusion detection system will remain up-to-date, without having to collect signatures of new attacks.

Intrusion detection systems or other monitoring systems, such as firewalls or network management systems, can trigger thousands of alarms per day with a high percentage of false positives, i.e. erroneous alarms. Indeed, up to 95% of false positives are not uncommon. It is therefore becoming widely accepted that alarms triggered by intrusion detection systems must be post-processed before they can beneficially be presented to a human analyst.

In S. Manganaris, M. Christensen, D. Zerkle, K. Hermiz; A Data Mining Analysis of RTID Alarms, 2^{nd} Workshop on Recent Advances in Intrusion Detection, 1999, a vision for a Network Operations Center (NOC) is shown, which receives alarms derived from a customer network for processing. Operators in the NOC are assisted by an automated decision engine, which screens incoming alarms using a knowledge-base of decision rules, which is updated by the assistance of a data mining engine that analyzes historical data and feedback from incident resolutions. It is further investigated whether the “normal” stream of alarms, generated by sensors under conditions not associated with intrusions or attacks, can be characterized. This approach is based on the idea that frequent behavior, over extended periods of time, is likely to be normal while a sudden burst of alarms, that never occurred before, may be related to misuse activities.

One problem with anomaly detection is that the normal alarm behavior of the monitoring system will change over time. This raises the need to regularly update the normal behavior model. Updating the model however involves further questions. Important is, to take care that the model does not assimilate malicious behavior so that corresponding alarms would no longer be detected as anomalies.

In conventional schemes, the model is periodically or continuously updated by “averaging” over the system's long-term alarm behavior. For example, model updates might be performed on a weekly basis. Alternatively, the model might be continuously updated to reflect the system's “average” behavior over the previous, say, three weeks. These methods work well as long as the system's normal alarm behavior is slowly drifting, but not suddenly and massively changing. However, it will take a long time to compensate a sudden decay of the model's performance which frequently occurs with a change in the configuration of the monitored system.

Further, even a perfectly optimized normal behavior model may cover alarms that originate from activities of an attacker. An attacker who his acquainted with the weaknesses of a network might predict what activities would cause alarms that would be regarded as normal or benign. Within this range of activities the attacker could attempt to stay undetected and hide behind the implemented model of normal behavior.

### OBJECTS OF THE INVENTION

It would therefore be desirable to create an improved method, a computer program element and a system for processing alarms triggered by a monitoring system such as an intrusion detection system, a firewall or a network management system in order to efficiently extract relevant information about the state of the monitored system or activities of its users.

It would be desirable in particular to create an improved method, a computer program element and a system for processing alarms by means of a model representing the normal alarm behavior of the monitoring system.

It would further be desirable to provide a method that allows to efficiently improve the over-all performance of the model. More specifically it would be desirable to provide a method that allows to rapidly reestablish the optimal condition of the model whenever required.

Further it would be desirable to provide a method that enables the easy detection of activities, which are relevant to the security of the monitored system, and which, in the event that a model representing the normal alarm behavior is used, might otherwise be considered as normal, despite originating from an attacker.

### SUMMARY OF THE INVENTION

In accordance with the present invention there is now provided a method, a computer program element and a system according to claim 1, claim 10 and claim 11.

The method and system process alarms that have been triggered by a monitoring system such as a knowledge-based or behavior-based intrusion detection system, a firewall or a network management system. In a preferred embodiment, the alarms are processed in a module that comprises a model representing the normal alarm behavior of the monitoring system, and, additionally, a set of rules that highlight relevant alarms that the model of normal alarm behavior might have otherwise suppressed.

The number of alarms, that have been triggered, and the number n_{f} of alarms, that have been filtered by means of the model, are counted. Then the ratio between the number of alarms, that have been filtered, and the number of alarms, that have been triggered, is calculated; and the update of the model is started whenever the ratio has reached a first or a second threshold value, as will be detailed below.

In order to efficiently achieve near-optimal over-all performance, an update of the model is performed, whenever a sharp decline in the model's performance is detected. Sharp declines in the model's performance are characterized by the ratio breaking through one of the previously mentioned thresholds. Typically, it is after the installation of new signatures or a reconfiguration of the monitored system, that the number of uncovered alarms increases substantially and breaks through one of the thresholds. Since attacks are relatively rare and usually stealthy, updating will never be triggered because of attacks.

Detection of performance drops further allows to return the model to optimal condition.

A reconfiguration of the monitored system may typically lead to a decay of the ratio r below a certain limit. For example, the ratio may drop to 0.5 (i.e. performance level 50%) or below. In a preferred embodiment of the invention the first threshold value indicates therefore an absolute limit for the ratio. A sharp decline or a slow drift of the ratio to that limit will always initiate an update of the model. The purpose of this update is to adjust the model to reflect the new characteristics of normal alarm behavior.

A reconfiguration of the monitored system may also lead to a decline of the model's performance, that is comparably small but still disturbing. In a further embodiment a second threshold value limits therefore a range in which the ratio may change within a given time-interval without initiating an update of the model. Specifically, an update will be performed if the ratio falls within a time-interval below the second threshold.

The first and second threshold values are preferably applied simultaneously so that significant performance drops are detected, immediately after a drift or sudden decay of the performance, causing the first threshold value to be reached, or after a small but significant decline of the performance within a time-interval, causing the second threshold value to be reached.

Even a perfectly optimized model of normal behavior may cover alarms which originate from activities of an attacker. In other words, an attacker might manage to “hide” under the model of normal alarm behavior and thus remain undetected. According to a further embodiment of the invention a high percentage of these alarms can be detected as follows. Alarms, that have been triggered, are grouped depending on source address information contained therein. Groups of alarms, that display diverse behavior, are flagged and forwarded for closer investigation.

In order to detect diverse behavior of a group of alarms, critical alarm attributes, such as ALARM-TYPE, TARGET-ADDRESS, TARGET-PORT and CONTEXT, are investigated. The CONTEXT-attribute is optional, but when present, contains the audit data that corresponds to the alleged attack. If a group of assembled alarms contains more than t, with t being a parameter, different values in one of the critical alarm attributes then this group has a higher probability of representing an attack. In consequence, it is forwarded for closer investigation.

This method, which allows to flag suspicious source systems, a source system being a group of alarms that agree in some aspect of their source attribute, is very efficient, so that it can be used with or without a model, that represents the normal alarm behavior of a monitoring system. However, using this method in conjunction with an anomaly detection model can significantly reduce the risk of missing attackers that try to hide behind the model of normal alarm behavior. Thus, detecting groups of alarms that display diverse behavior and detecting abnormal alarm behavior are techniques that complement each other and allow to efficiently discover and prioritize the most relevant alarms for further processing.

### BRIEF DESCRIPTION OF THE DRAWINGS

Some of the objectives and advantages of the present invention have been stated, others will appear when the following description is considered together with the accompanying drawings, in which:

FIG. 1 shows a schematic view of a computer network topology comprising firewalls and a DMZ;

FIG. 2 shows a graph over a longer time period of the ratio n_{f}/nₜ between the number n_{f} of alarms, that have been filtered by means of a model, and the total number nₜ of alarms, that have been triggered by a monitoring system;

FIG. 3 shows a section of the graph of FIG. 2, in which an update of the model was performed;

FIG. 4 shows different source systems communicating with a secure network; and

FIG. 5 shows an alarm log with grouped alarms.

### DETAILED DESCRIPTION OF THE PREFERRED EMBODIMENTS

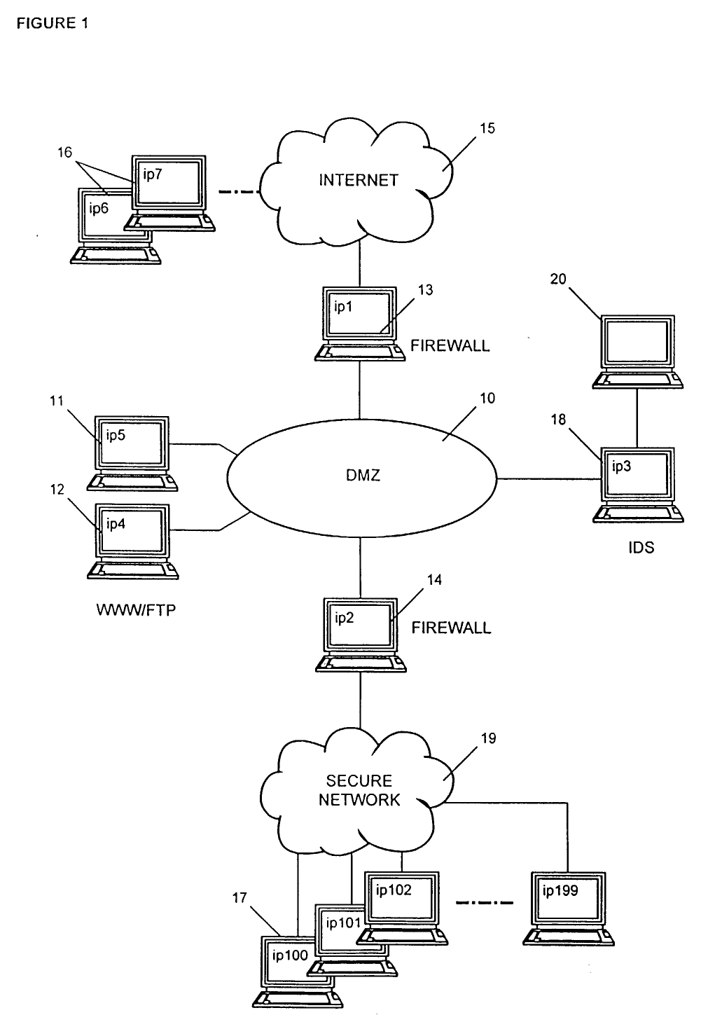

FIG. 1 shows a schematic view of a computer network topology comprising firewalls 13, 14 and a demilitarized zone 10, below referred to as DMZ. DMZ is a term often used when describing firewall configurations. The DMZ 10 is an isolated subnet between a secure network 19 and an external network such as the Internet 15. Clients 16 operating in the Internet 15 may access Web servers and other servers 11, 12 in the DMZ 10, which are provided for public access. The servers 11, 12 are protected to some degree by placing an outer firewall 13, which could be a packet-filtering router, between the Internet 15 and the servers 11, 12 in the DMZ 10. The outer firewall 13 forwards only those requests into the DMZ 10 which are allowed to reach the servers 11, 12. Further the outer firewall 13 could also be configured to block denial-of-service attacks and to perform network address translation for the servers 11, 12 in the DMZ 10. The inner firewall 14 is designed to prevent unauthorized access to the machines 17 in the secure network 19 from the DMZ 10 and perhaps to prevent unauthorized access from the machines 17 of the secure network 19 to the DMZ 10 or the Internet 15. Network traffic in the DMZ 10 is sensed and analyzed by an intrusion detection system 18 which, as described above, triggers alarms when detecting patterns of attacks or anomalous behavior.

Intrusion detection systems, that operate knowledge-based or behavior-based, can trigger a high number of alarms per day. Typically 95% of these alarms are false positives, i.e. alarms that incorrectly flag normal activities as malicious. That way, human operators are confronted with an amount of data, that is hard to make sense of. Intrusion detection alarms are repetitive and redundant, so that they can be partially modeled and subsequently suppressed in the future. In other words, the normal and repetitive alarm behavior of an intrusion detection system can be modeled and only alarms that are not covered by the model, are flagged. The rationale of this approach is, that frequent/repetitive alarms contain no new information. In fact, if a class of alarms is known to occur, then there is no need to continuously reassert this fact. Thus, by modeling and suppressing frequent/normal alarms it becomes possible to highlight the unprecedented and relevant alarms.

Hence, only a comparably small number of alarms, namely those outside the model, are forwarded to an analyst for further processing.

A fundamental problem with anomaly detection is, that the normal behavior of the monitored system changes over time. This raises the need to update the model from time to time. In general, choosing the right timing for these updates is critical. According to a conventional scheme, the model is updated periodically, for example weekly, by “averaging” the alarm behavior observed over the long run. This long-term average behavior is defined to be the normal behavior. In this known scheme, it takes therefore a long time until the model adjusts to sudden and massive behavior changes. Indeed, in the case of sudden and massive changes, the model will significantly lag behind the actual alarm behavior of the monitoring system.

In the herein proposed method, however, the number nₜ of alarms, that have been triggered, and the number n_{f} of alarms, that have been filtered by means of the model, which represents a normal behavior of the triggered alarms, are counted. Then the ratio r=n_{f}/nₜ between the number n_{f} of alarms, that have been filtered, and the number nₜ of alarms, that have been triggered, is calculated.

FIG. 2 shows a graph of the calculated ratio r over a longer time period. In case that the model would cover all triggered alarms then the ratio r would be 1. Since a certain percentage of the alarms is always related to anomalous behavior, possibly to malicious activities and model imperfections, the ratio r will in practice be below 1.

In accordance with the present invention, an update of the model is initiated when the ratio r has reached a threshold value. In the example shown in FIG. 2 the first threshold value v_{S} is set at 0.5. At the time tᵤ₁, when the ratio r reaches the value 0.5, an update is performed to reestablish near-optimal conditions of the model.

Performance of the model may slowly or sharply decline. In the example shown in FIG. 2, before time tᵤ₁ the model's performance had been drifting towards the first threshold value v_{S}. A slow drift may be caused by behavior changes of the users of the monitored system.

A sharp performance decline, as shown in the graph shortly before time tᵤ₂ in the graph of FIG. 2 is typically experienced after the installation of new signatures or a reconfiguration of the monitored system. Although the decline obviously indicates a severe change in the system, the ratio r does not reach the first threshold value v_{S}. Based on the first threshold value v_{S} an update, which would compensate for the system's changes, is therefore not initiated.

Therefore, according to a further embodiment of the invention the change of the ratio r is observed within short time-intervals T. A second threshold value v_{D} is provided that limits the decline which the ratio r may experience within a time-interval T without initiating another update of the model. Specifically, a model update is initiated if the ratio r drops within a time-interval T by v_{D} or more.

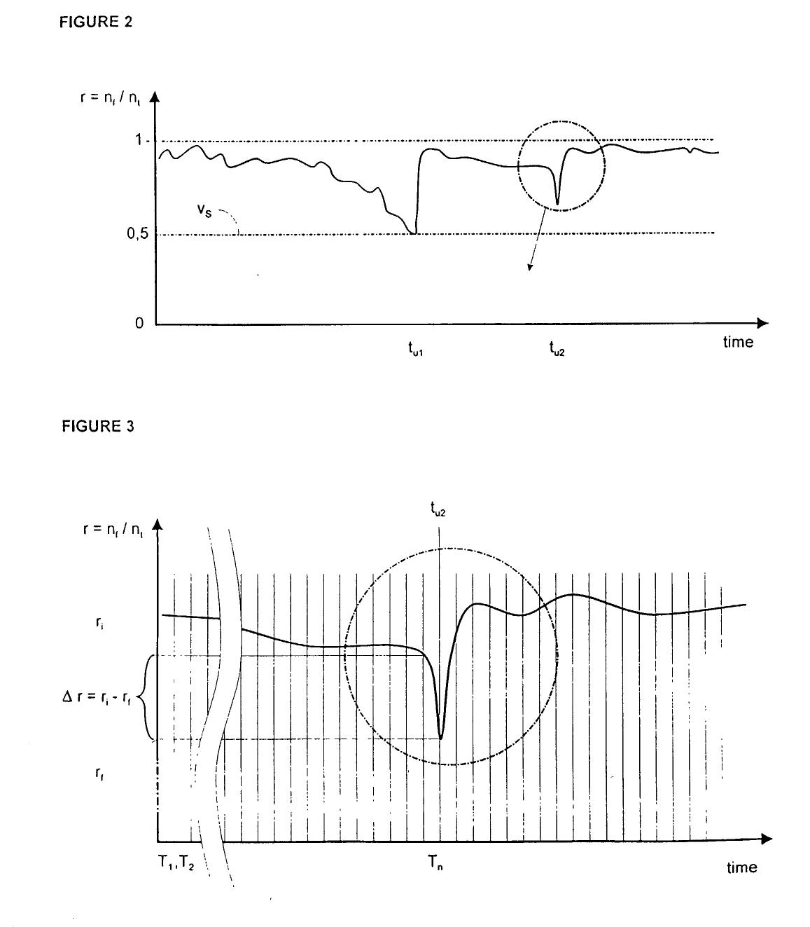

FIG. 3 shows the section of the graph of FIG. 2 in which the decline of the ratio r at time tᵤ₂ occurred. It can be seen that the ratio r changed in the time-interval Tₙ from an initial value rᵢ to a final value r_{f} resulting in a change Δr=−(r_{f}−rᵢ). Since the change Δr exceeded the second threshold value v_{D} (i.e. Δr>v_{D}), a further model update is initiated. As shown in FIG. 3, model performance (as measured by the ratio r=n_{f}/nₜ) rebounds after the model update.

Preferably, the ratio r and its changes Δr are simultaneously compared with the first and the second threshold values v_{S} and v_{D}. Using the first threshold value v_{S} allows immediate detection of a decay of the performance of the model (r<v_{S}). For values of the ratio r above the first threshold value v_{S} (r>v_{S}), sharp declines of the performance of the model can still be detected by means of the second threshold value v_{D}.

In a preferred embodiment, the threshold values v_{S}, v_{D1}, . . . , v_{Dn}, and/or the size of the time-intervals T₁, . . . , Tₙ may statically be set or dynamically be calculated and modified during the runtime of the system.

The model representing the normal behavior of the triggered alarms is therefore updated, as soon as a significant decline of its performance occurs. Since the level of change is known, the appropriate measure can be taken in order to reestablish optimal performance of the model. This process is also known as relearning the model.

Regardless of its condition, a model of normal behavior may cover alarms which originate from activities of an attacker. An attacker who is acquainted with a network might predict what activities would cause alarms that are regarded as normal. Within this range of activities the attacker could attempt to misuse a target system and “hide” behind the implemented model of normal alarm behavior. According to a further embodiment of the invention, most of these otherwise suppressed alarms can be maintained as described below.

Alarms, that have been triggered, are grouped depending on source address information contained therein. Groups of alarms, that display diverse behavior, are flagged and forwarded for closer investigation.

The source system that is used for grouping alarms may be very specific, and consist of the complete source IP-address. Alternatively, the source system may be more general and consist of a set of IP-addresses such as the set of IP-addresses in a particular subnet or the set of IP-addresses that have been assigned to a host, see Douglas E. Comer, INTERNETWORKING with TCP/IP, PRINCIPLES, PROTOCOLS, AND ARCHITECTURES, 4th EDITION, Prentice Hall 2000, pages 64-65.

In order to detect diverse behavior of a source system, critical alarm attributes A₁, . . . , Aₙ, such as ALARM-TYPE, TARGET-ADDRESS, TARGET-PORT and CONTEXT, are investigated. Specifically, sets of alarms which have pairwise distinct values for a critical alarm attribute and which originate from the same source system (e.g. the same source network or the same source host) are assembled in a group. In the event that the number of assembled alarms exceeds a given threshold value then this group is forwarded for closer investigation in order to identify root causes.

This method, which allows to flag suspicious source systems, is very efficient, so that it can be used with or without a model, that represents the normal alarm behavior of the monitoring system. However, using this method in conjunction with an optimized model further increases processing efficiency significantly. Detecting groups of alarms, which pass a normal behavior model or which display diverse behavior, allows to discover the most relevant alarms for further processing.

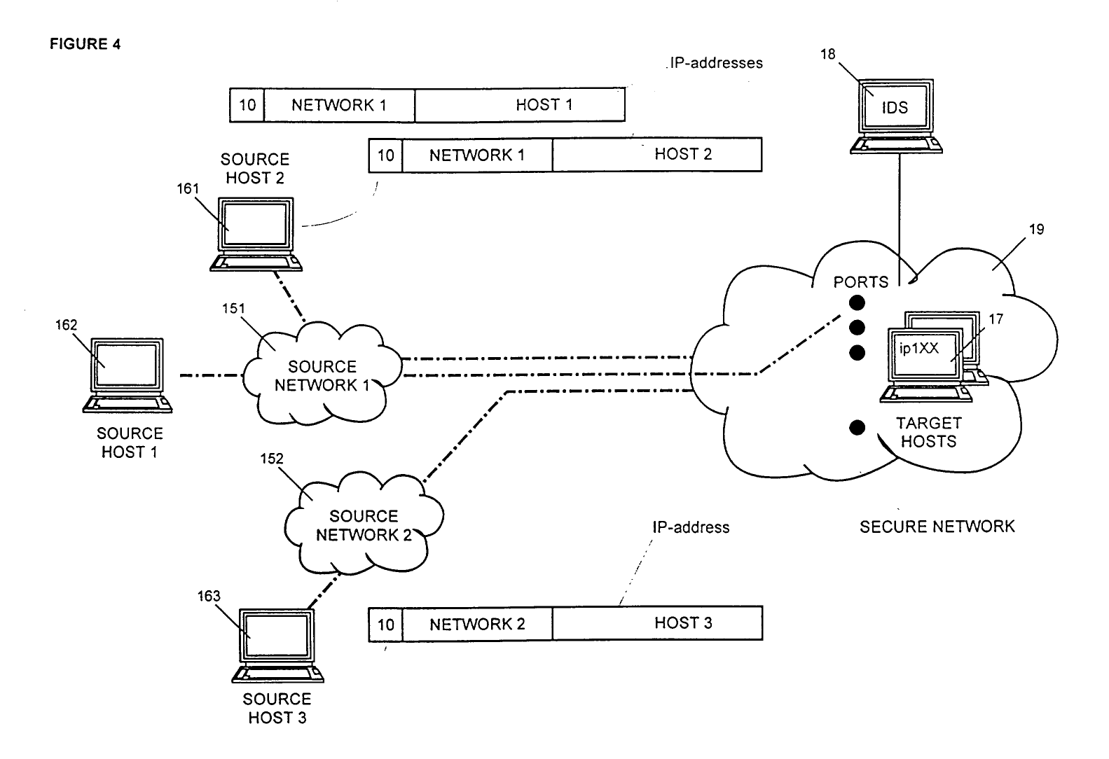

FIG. 4 shows different source systems, such as hosts 161, 162 operating in sub-network 151 and host 163 operating in sub-network 152 of the Internet, communicating with hosts 17 operating in a secure network 19. Shown are further the IP-addresses of the source hosts 161, 162 and 163.

Source host 1 in the given example causes alarms by activities directed against various ports of a target host 17 connected to the secure network 19. The intrusion detection system 18 will detect these attempts to intrude the target host 17 and will therefore trigger corresponding alarms that typically contain the attributes A₁, . . . , Aₙ mentioned above. Compared to other hosts, which normally access only one port on a destination host 17 and which therefore display a monotonous behavior, source host 1 obviously displays a diverse behavior, indicating malicious activities of an attacker.

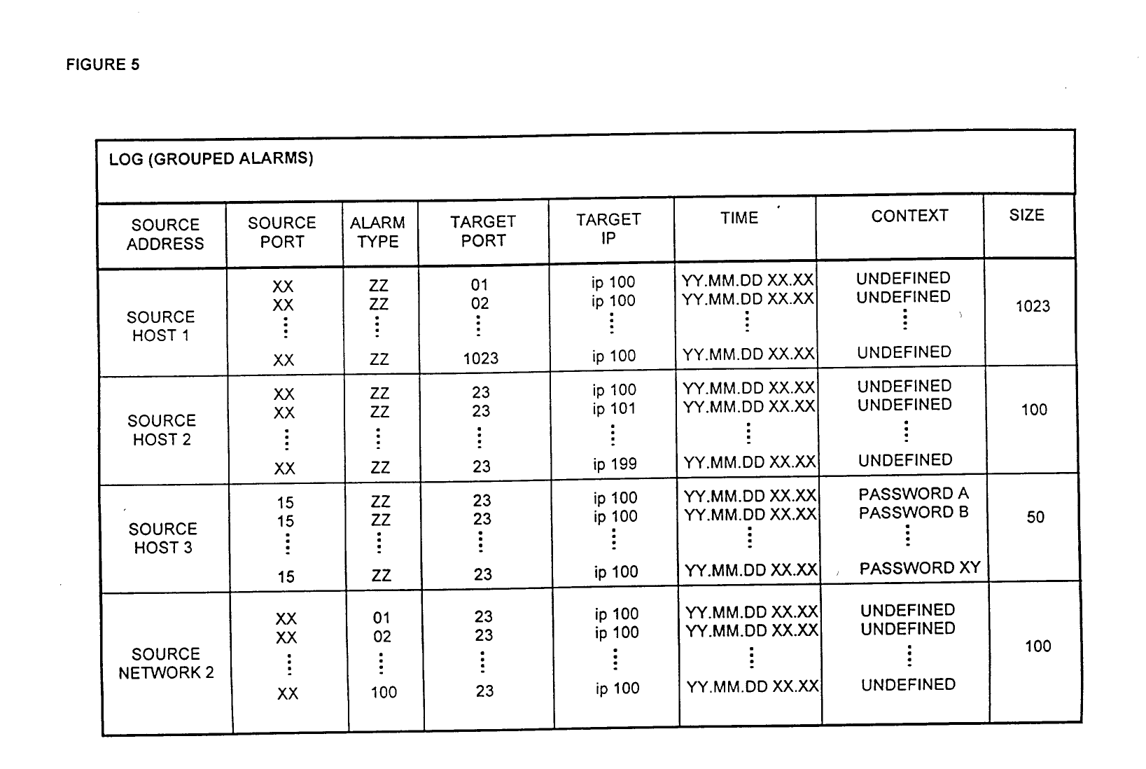

FIG. 5 shows a table containing alarms with attributes A₁, . . . , Aₙ and grouped according to source address information. The number of alarms contained in each group is listed in the size column.

1023 alarms caused by source host 1 are listed as a first group in the table. The alarms of this first group have pairwise distinct values for the TARGET-PORT attribute. Assuming that a group size of 1023 is larger than the threshold value v_{D·PORT} assigned to the TARGET-PORT-attribute, this group is flagged and forwarded for closer investigation.

Since the majority of source hosts display a monotonous behavior, the threshold values v_{D PORT} for detecting diverse behavior can be set rather low in order to obtain a high sensitivity while still maintaining a low false alarm rate. According to given requirements, threshold values v_{D·A1}, . . . , v_{D·An} can be selected individually for each attribute A₁, . . . , Aₙ. The threshold value v_{D·PORT} for the TARGET-PORT-attribute may be set lower, for example to 3, than the threshold value v_{D·IP} for the TARGET-IP-attribute, since it is not uncommon that a source host will contact more than one target host in a destination network while trying to access several ports on a single target host is statistically rare.

Further, the threshold values v_{D·A1}, . . . , v_{D·An} can be set statically, or they can be modified dynamically during the runtime of the system.

In the table of FIG. 5 further groups of alarms are listed, that indicate diverse behavior of the respective source systems. Source host 2 has been registered for trying to access target port 23 of a plurality of target hosts 17 in the secure network 19. Source host 3 has caused alarms indicating a diverse behavior in the CONTEXT-attribute. An investigation of these alarms indicates that a password attack has taken place. The last group contains alarms caused by several machines operating in source network 2. The alarms of this group comprise different alarm types. The alarm type is an integer number or a symbolic name that encodes the actual attack that has been observed. For example, the number 11 might denote a particular buffer-overflow attack. Analogously, alarm type 15, which is triggered by source host 3, could denote “FAILED LOGIN ATTEMPT”.

The proposed method therefore allows to isolate relevant alarms which can easily be evaluated and met by corresponding countermeasures.

What has been described above is merely illustrative of the application of the principles of the present invention. Other arrangements can be implemented by those skilled in the art without departing from the spirit and scope of protection of the present invention. In particular the application of the inventive method is not restricted to processing alarms sensed by an intrusion detection system. The inventive method can be implemented in any kind of decision support application, that processes large amounts of data.

The proposed method can be implemented by means of a computer program element operating in a system 20 as shown in FIG. 1 that is arranged subsequent to a monitoring system. As described in document U.S. Pat. No. 6,282,546 B1, a system designed for processing data provided by a monitoring system may be based on known computer systems having typical computer components such as a processor and storage devices, etc.. For example, the system 20 may comprise a database which receives processed data and which may be accessed by means of a user interface in order to visualize processed alarms.

1. A method for processing alarms that have been triggered by a monitoring system, in a subsequent system of a type employing a model representing normal alarm behavior of the monitoring system, the method comprising the steps of:
a) counting a number of alarms that have been triggered, and a number of alarms that have been filtered by the model, within at least one time-interval;
b) calculating a ratio between the number of alarms that have been filtered, and the number of alarms that have been triggered; and
c) updating the model in response to the ratio reaching a threshold value.

2. The method according to claim 1, wherein a first threshold value is used to indicate an absolute lower bound for the ratio and a second threshold value is used to limit the maximum decline that the ratio may experience within a given time-interval without initiating an update of the model.

3. The method according to claim 2, further comprising the step of comparing the ratio with the first and the second threshold value.

4. The method according to claim 1, wherein multiple of said threshold values and different time-intervals are used which are one of statically set and dynamically calculated.

5. A method for processing alarms, that have been triggered by a monitoring system, the method comprising the steps of:
a) grouping alarms, that have been triggered, according to source address information,
b) detecting groups of alarms that display diverse behavior and
c) forwarding detected groups of alarms for further processing.

6. The method according to claim 5, wherein said detecting step further comprises a step of grouping alarms that contain different values for critical alarm attributes.

7. The method according to claim 6, further comprising the step of assigning at least one threshold value that is one of statically set and dynamically calculated, to each said critical alarm attribute.

8. The method according to claim 7, wherein said grouping step further comprises the step of grouping alarms with pairwise different values for a critical alarm attribute such that a number of alarms exceeds an assigned threshold value.

9. The method according to claim 5, wherein said detecting step further comprises the step of investigating said groups in order to identify a root cause.

10. A computer program element comprising computer program code which, when loaded in a processor of a data processing system, configures the processor to perform a method as claimed in claim 1.

11. A computer program element comprising computer program code which, when loaded in a processor of a data processing system, configures the processor to perform a method as claimed in claim 5.
